(19) United States
(12) Patent Application Publication
(10) Pub. No.: US 2014/0033920 A1
(43) Pub. Date: Feb. 6, 2014

(54) ENHANCED PARTIALLY-AMINATED METAL-ORGANIC FRAMEWORKS

(71) Applicants: Michael P. Tate, Midland, MI (US); Scott T. Matteucci, Midland, MI (US); Shawn D. Feist, Midland, MI (US); Dean M. Millar, Midland, MI (US)

(72) Inventors: Michael P. Tate, Midland, MI (US); Scott T. Matteucci, Midland, MI (US); Shawn D. Feist, Midland, MI (US); Dean M. Millar, Midland, MI (US)

(73) Assignee: Dow Global Technologies LLC, Midland, MI (US)

(21) Appl. No.: 13/978,161

(22) PCT Filed: Feb. 20, 2012
(86) PCT No.: PCT/US12/25774

§ 371 Date: Jul. 3, 2013

Related U.S. Application Data
(60) Provisional application No. 61/445,215, filed on Feb. 22, 2011.
(60) Provisional application No. 61/477,227, filed on Apr. 20, 2011.

(51) Int. Cl. B01J 20/22

(52) U.S. Cl. CPC B01J 20/226
USPC 95/139; 96/108; 502/401

(57) ABSTRACT

Described is an enhanced partially-aminated metal-organic framework comprising, or prepared from, metal cations and a synergistically effective ratio of a multi-carboxylic acid and an amino-substituted derivative of the multi-carboxylic acid, or the acceptable salts thereof, or any combination thereof; a manufactured article comprising the enhanced partially-aminated metal-organic framework; a method of preparing the enhanced partially-aminated metal-organic framework, and a method of using the enhanced partially-aminated metal-organic framework for separating carbon dioxide gas or other acid gas from an ad rem gas mixture.

The invention generally relates to an enhanced partially-aminated metal-organic framework, and manufactured article comprising same; methods of preparing same, and a method of using same for separating carbon dioxide gas from an ad rem gas mixture.

Certain metal-organic frameworks (MOFs) have been investigated for carbon dioxide (CO₂) gas removal applications (e.g., for preventing CO₂ gas from entering earth's atmosphere, entrance of which could lead to global warming). Generally, a MOF is a crystalline compound wherein metal cations are spaced apart from each other by organic ligand molecules and can be characterized by its degree of porosity. Various combinations of a metal cation and an organic molecule have been tried for preparing MOFs for CO₂ gas chemisorption (“CO₂-sorption” for short), but due to inherent unpredictability of the MOF and CO₂ gas chemisorption art, an ideal MOF material has not been found. This is partly because there are a large number of choices for the metal cation and organic ligand compositions, and their combinations can lead to a large number of different MOFs with variabilities in structural characteristics (e.g., porosity) and performance (e.g., CO₂ gas chemisorption activity). For example, US 2007/0068389 A1 mentions, among other things, a carbon dioxide storage system that includes, among other things, “MOF-2,” “IRMOF-1,” and “IRMOF-3” (see FIG. 5). The MOF-2 is a non-aminated MOF prepared from anhydrous ZnCl₂ and terephthalic acid in a mixture of dimethylformamide (DMF) and aqueous methylamine. The IRMOF-1 is a non-aminated MOF prepared from Zn(NO₃)₂.4H₂O and terephthalic acid in diethylformamide (DEF). The IRMOF-3 1 is a 100% aminated MOF prepared from Zn(NO₃)₂.4H₂O and 2-amino-terephthalic acid in DEF. As seen in FIGS. 5 to 7, the MOFs of US 2007/0068389 A1 have wide variation in surface area and CO₂-sorption activity. US 2007/0068389 A1 does not disclose or suggest any MOF prepared from a metal and a mixture of different ligands. US 2010/0126344 A1 also mentions, among other things, MOF-2, IRMOF-1 and IRMOF-3. US 2010/0126344 A1 does not mention an example of a MOF prepared from a mixture of different ligands. US 2007/0068389 A1 and US 2010/0126344 A1 do not disclose or suggest any partially-aminated MOF.

A problem addressed by the present invention includes providing a metal-organic framework having enhanced total pore volume or enhanced CO₂ gas chemisorption capacity.

### BRIEF SUMMARY OF THE PRESENT INVENTION

In a first embodiment the present invention provides an enhanced partially-aminated metal-organic framework characterizable in its active-pore form by a synergistic CO₂ gas sorption effect.

In a second embodiment the present invention provides a process for making an enhanced partially-aminated metal-organic framework characterizable in its active-pore form by a synergistic CO₂ gas sorption effect, the process comprising contacting in a dispersion medium a metal salt with a synergistically effective ratio of a multi-carboxylic acid and an amino-substituted derivative of the multi-carboxylic acid, or acceptable salts thereof, or any combination thereof, and allowing the enhanced partially-aminated metal-organic framework to form and crystallize therefrom, the enhanced partially-aminated metal-organic framework defining a plurality of pores. Typically, the enhanced partially-aminated metal-organic framework (enhanced PAMOF) comprises a plurality of metal cations of the metal salt; molecules of the multi-carboxylic acid and an amino-substituted derivative of the multi-carboxylic acid, or the acceptable salts thereof, or any combination thereof; and a charge neutralizing number of anions of the metal salt such that the enhanced PAMOF is formally neutral.

In a third embodiment the present invention provides the enhanced PAMOF as prepared by the process of the second embodiment. In some embodiments the enhanced PAMOF of the first or third embodiment contains some of the dispersion medium and is called herein a blocked-pore form (BPF) thereof. In other embodiments the enhanced PAMOF lacks the dispersion medium so that it is an active-pore form (APF) thereof characterizable by the synergistic CO₂ gas sorption effect. The BPF can be, and preferably is, activated to give the APF. The activation of the BPF comprises substantially removing the dispersion medium therefrom.

In a fourth embodiment the present invention provides a manufactured article comprising the enhanced PAMOF of the first or third embodiment.

In a fifth embodiment the present invention provides a separation method of separating an acid gas from a separable gas mixture comprising the acid gas and at least one adsorption-resistant gas, the method comprising contacting the active-pore form of the enhanced PAMOF with the separable gas mixture; allowing the acid gas of the separable gas mixture to penetrate into the pores of, and adsorb onto, the enhanced PAMOF; and removing an enriched adsorption-resistant gas portion of the separable gas mixture from the enhanced PAMOF, wherein the enriched adsorption-resistant gas portion of the separable gas mixture has a lower concentration of the acid gas than does the separable gas mixture. The separation method separates at least some of at least one acid gas from the separable gas mixture. Preferably, the acid gas is carbon dioxide (CO₂) gas.

In a sixth embodiment the present invention provides an enhanced partially-aminated metal-organic framework characterizable in its active-pore form by a synergistic total pore volume effect.

The multi-carboxylic acid and amino-substituted derivative thereof, or the acceptable salts thereof, or any combination thereof, and the metal salt are useful for preparing the enhanced PAMOF, and both the blocked-pore and active-pore forms of the enhanced PAMOF are useful for preparing the manufactured article. The active-pore form of the enhanced PAMOF, manufactured article comprising the active-pore form of the enhanced PAMOF, and separation process are useful for separating the acid gas from the separable gas mixture. The invention advantageously can be used to remove CO₂ gas (or SO₂ gas or both) from a separable gas mixture comprising CO₂ gas (or SO₂ gas or both) and the adsorption-resistant gas, and can be used in any application where such removing of CO₂ gas is desirable. The separation method is particularly useful for flue gas or natural gas “sweetening” applications (i.e., applications that remove acid gas from flue or natural gas). The present invention contemplates other uses for the enhanced PAMOF and manufactured articles. Examples of such other uses are as an active component of a house wrap or other barrier material and as a solid support component of a heterogeneous catalyst comprising a catalytically effective amount of a catalytic metal in contact with the solid support component.

The present invention provides a number of advantages. For example, the enhanced PAMOF and manufactured article can take advantage of newly discovered synergistically effective CO₂ gas chemisorption capacity, total pore volume capacity, or both thereof compared to lesser capacities of chemisorption of CO₂ gas by or total pore volumes of corresponding non-invention MOFs comprising metal cations and multi-carboxylic acids that are either 100 percent multi-carboxylic acid, anion forms (conjugate base) thereof, or a combination thereof (i.e., a 0 percent-aminated MOF) or 100 percent amino-substituted derivative of the multi-carboxylic acid, anion forms (conjugate base) thereof, or a combination thereof (i.e., 100 percent aminated MOF). The synergistic effects are preferably based on comparisons using the same molar ratio of moles of the metal to total number of moles of the multi-carboxylic acid and an amino-substituted derivative of the multi-carboxylic acid, or acceptable salts thereof.

Additional embodiments are described in the accompanying drawing(s) and the remainder of the specification, including the claims.

### BRIEF DESCRIPTION OF THE DRAWING(S)

Some embodiments of the present invention are described herein in relation to the accompanying drawing(s), which will at least assist in illustrating various features of the embodiments.

FIG. 1 graphically presents CO₂ gas sorption obtained with the materials of Example 1 (Run 1), Example 5, and Example 7 (Run 1).

FIG. 2 graphically presents a PXRD pattern obtained with the material of Example 1 (Run 1).

### DETAILED DESCRIPTION OF THE PRESENT INVENTION

The embodiments of the present invention summarized previously and the Abstract are incorporated here by reference. For convenience, the multi-carboxylic acid and anionic forms thereof (multi-carboxylate anions), of the acceptable salt of multi-carboxylic acid, are collectively referred to herein as “multi-carboxylic/carboxylate species.” For convenience, the amino-substituted derivative of the multi-carboxylic acid and anionic forms thereof (amino-substituted multi-carboxylate anions), of the acceptable salt of amino-substituted derivative of the multi-carboxylic acid, are collectively referred to herein as “amino-substituted multi-carboxylic/carboxylate species.” As used herein the term “acceptable salts” means a composition comprising an inorganic or (C₁-C₁₂) organic cation and anionic forms of the multi-carboxylic/carboxylate species. The term “acid gas” means a substance that can be characterized as being vaporous or gaseous at 30 degrees Celsius (° C.) and having at least one of the following capabilities (a) to (c): (a) functioning as a Lewis acid (e.g., CO₂ gas) or Brønsted acid (e.g., H₂S gas); (b) preferably, if dissolved in pure water to a concentration of 1 wt %, forming an aqueous mixture having a potential of hydrogen (pH) of <pH 7.0; or (c) a combination thereof. The term “acid gas separating effective amount” means a quantity sufficient to enable physical distancing or removing of the vaporous or gaseous substance (from a remainder of the separable gas mixture). The term “adsorption-resistant gas” means a gaseous or vaporous non-acidic molecule, or mixture comprising same, that is inhibited, slowed (e.g. has a lower permeation rate), or stopped from penetrating (e.g., by diffusion or other mechanisms) all the way through a material. The phrase “contacting” (as in contacting with) and the like means causing a coming together or touching. The term “enhanced” means capable of having, or being activated to having, a synergistic or greater than additive effect. The expression “enriched in” means having a greater concentration of. The term “flue gas” means an exhaust gas mixture from a combustion process. The term “manufactured article” means a member of a class of things, wherein the member is not found in nature. The term “metal cation” means a positively charged element selected from any one of Groups 1 to 16 of the Periodic Table of the Elements including the actinide and lanthanide metals, or a metal cluster comprising at least two different metal atoms thereof. As used herein, the term “metal cluster” means a polynuclear moiety comprising at least two metal atoms having direct metal-metal bonding therebetween, wherein each metal atom independently is an element selected from any one of Groups 1 to 16 of the Periodic Table of the Elements including the actinide and lanthanide metals. The term “metal salt” means an ionic substance comprising a cation of at least one metal cation and a suitable organic or inorganic anion. The term “metal-organic framework” or MOF generally means a crystalline material wherein individual metal cations, metal clusters, or a combination thereof are spaced apart from each other by organic polydentate anions to form a one-, two-, or, preferably, three-dimensional periodic structure. The term “multi” means at least two, preferably at most 4, and more preferably at most 3, and still more preferably 2. The term “partially-aminated” means some, but not all, of the polydentate molecules of the MOF are substituted with a pendant amino-containing substituent of formula —R—NH₂, wherein each R independently is (C₁-C₃)alkylene or, preferably, is absent. The term “multi-carboxylic acid” means a substituted (C₂-C₂₀)hydrocarbylene or substituted (C₂-C₂₀)heterohydrocarbylene containing at least two —CO₂H substituents, and preferably at most 4, more preferably at most 3 CO₂H substituents. The term “amino-substituted derivative of the multi-carboxylic acid” means the multi-carboxylic acid as defined above that is also substituted between the at least two —CO₂H substituents with the group of formula —R—NH₂, wherein each R independently is (C₁-C₃)alkylene or, preferably, is absent. The term “natural gas” means methane gas-containing gas mixtures comprising at least 50 mol % methane gas (typically at least 85 mol % methane gas). The term “permeant gas” means a gaseous or vaporous substance that has penetrated (e.g., by diffusion or other mechanisms) into, and preferably also passed out of the enhanced PAMOF. The term “pore” means a volumetric space defined by a portion of the structure of the enhanced PAMOF. The term “active pore” means the volumetric space under vacuum or containing molecule(s) of a gaseous substance (at 20° C.), wherein the molecule(s) independently are adsorbed onto the enhanced PAMOF structure or unadsorbed. The terms “blocked pore” and “filled pore” are synonymous and mean the volumetric space contains a solid or liquid substance (at 20° C.). The term “removing” (from the enhanced PAMOF) means passively transporting away (e.g., allowing diffusion) or actively transporting away (applying a vacuum source or sweeping with a carrier gas). As used herein in the context of removing the acid gas (e.g., CO2 gas), the term “separable gas mixture” means a gaseous or vaporous fluid composition comprising a blend of the acid gas (e.g., CO2 gas) and the at least one adsorption-resistant gas. At least some of the acid gas can be removed from the separable gas mixture according to the separation method or using the active-pore form of the enhanced PAMOF, or preferably both. The term “separating” means physically distancing or removing. The term “synergistically effective ratio” is a relation in degree, preferably expressed as a molar ratio range of <90 mol % and >10 mol %, of the total amino-substituted multi-carboxylic/carboxylate species to total multi-carboxylic/carboxylate species that is sufficient for leading to or providing a PAMOF composition (i.e., the enhanced PAMOF) that is characterizable by an unexpectedly synergistically effective chemisorption of CO₂ gas compared to chemisorption of CO₂ gas by the corresponding non-invention MOFs. Non-invention MOFS are the 0 percent-aminated MOF (lacking amino-substituted multi-carboxylic/carboxylate species); the 100 percent aminated MOF (lacking multi-carboxylic/carboxylate species); and partially aminated MOFs outside the molar ratio range.

Conflict Resolution: The structure controls any conflict with a compound name. The unit value recited without parentheses controls any conflict with an intended corresponding unit value that is parenthetically recited.

Numerical ranges: any lower limit of a range of numbers, or any preferred lower limit of the range, may be combined with any upper limit of the range, or any preferred upper limit of the range, to define a preferred aspect or embodiment of the range. Unless otherwise indicated, each range of numbers includes all numbers, both rational and irrational numbers, subsumed in that range (e.g., “from 1 to 5” includes, for example, 1, 1.5, 2, 2.75, 3, 3.81, 4, and 5).

Unless otherwise noted, the phrase “Periodic Table of the Elements” refers to the official periodic table, version dated Jun. 22, 2007, published by the International Union of Pure and Applied Chemistry (IUPAC). Also any references to a Group or Groups shall be to the Group or Groups reflected in this Periodic Table of the Elements.

The term “(C₂-C₂₀)hydrocarbylene” means a hydrocarbon multi-radical of from 2 to 20 carbon atoms wherein each hydrocarbon multi-radical independently is aromatic (i.e., (C₆-C₂₀)arylene, e.g., phenyl) or non-aromatic (i.e., (C₂-C₂₀) aliphatic multi-radical); saturated (i.e., (C₂-C₂₀)alkylene or (C₃-C₂₀)cycloalkylene) or unsaturated (i.e., (C₂-C₂₀)alkenylene, (C₂-C₂₀)alkynylene, or (C₃-C₂₀)cycloalkenylene); straight chain (i.e., normal-(C₂-C₂₀)alkylene) or branched chain (e.g., secondary-, iso-, or tertiary-(C₃-C₂₀)alkylene); cyclic (at least 3 carbon atoms, (i.e., (C₆-C₂₀)arylene, (C₃-C₂₀)cycloalkenylene, or (C₃-C₂₀)cycloalkylene, including mono- and polycyclic, fused and non-fused polycyclic, including bicyclic; or acyclic (i.e., (C₂-C₂₀)alkylene, (C₂-C₂₀)alkenylene, or (C₂-C₂₀)alkynylene); or a combination of at least two thereof (e.g., (C₃-C₁₀)cycloalkylene-(C₁-C₁₀)alkyl or (C₆-C₁₀) arylene-(C₁-C₁₀)alkyl). The radicals of the hydrocarbon multi-radical can be on same or, preferably, different carbon atoms. Other hydrocarbylene groups (e.g., (C₂-C₁₀)hydrocarbylene and (C₂-C₆)hydrocarbylene)) are contemplated and defined in an analogous manner. Preferably, a (C₂-C₂₀)hydrocarbylene independently is an unsubstituted or substituted (C₂-C₂₀)alkylene, (C₃-C₂₀)cycloalkylene, (C₃-C₁₀)cycloalkylene-(C₁-C₁₀)alkyl, (C₆-C₂₀)arylene, or (C₆-C₁₀)arylene-(C₁-C₁₀)alkyl. In some embodiments the (C₂-C₂₀)hydrocarbylene is a (C₆-C₁₈)arylene, more preferably (C₆-C₁₀)arylene, and still more preferably phenylene.

The term “(C₂-C₂₀)heterohydrocarbylene” means a heterohydrocarbon multi-radical of from 2 to 20 carbon atoms and from 1 to 6 heteroatoms; wherein each heterohydrocarbon multi-radical independently is aromatic (i.e., (C₂-C₂₀)heteroarylene, e.g., thiophen-2,5-diyl, pyridine-2,6-diyl, and indol-1,5-diyl) or non-aromatic (i.e., (C₂-C₂₀)heteroaliphatic multi-radical); saturated (i.e., (C₂-C₂₀)heteroalkylene or (C₂-C₂₀)heterocycloalkylene) or unsaturated (i.e., (C₂-C₂₀)heteroalkenylene, (C₂-C₂₀)heteroalkynylene, or (C₂-C₂₀)heterocycloalkenylene); straight chain (i.e., normal-(C₂-C₂₀)heteroalkylene) or branched chain (i.e., secondary-, iso-, or tertiary-(C₃-C₂₀)heteroalkylene); cyclic (at least 3 ring atoms, (i.e., (C₂-C₂₀)heteroarylene, (C₂-C₂₀)heterocycloalkenylene, or (C₂-C₂₀)heterocycloalkylene, including mono- and poly-cyclic, fused and non-fused polycyclic, including bicyclic); or acyclic (i.e., (C₂-C₂₀)heteroalkylene, (C₂-C₂₀)heteroalkenylene, or (C₂-C₂₀)heteroalkynylene); or a combination of at least two thereof (e.g., (C₃-C₁₀)cycloalkylene-(C₁-C₁₀)heteroalkyl or (C₁-C₁₀)heteroarylene-(C₁-C₁₀)alkyl). The radicals of the heterohydrocarbon multi-radical can be on a carbon atom. Other heterohydrocarbylene groups (e.g., (C₂-C₁₀)heterohydrocarbylene)) are contemplated and defined in an analogous manner.

Unless otherwise indicated, each hydrocarbon multi-radical and heterohydrocarbon multi-radical independently is substituted only by the carboxyl substituents or, in other embodiments; at least one is further substituted by at least 1, preferably 1 to 6, further substituents, R^{S}. In some embodiments each R^{S} independently is selected from the group consisting of a halogen atom (halo); any one of polyfluoro and perfluoro substitution, unsubstituted (C₁-C₁₈)alkyl; F₃C—; FCH₂O—; F₂HCO—; F₃CO—; R^{V}₃Si—; R^{G}O—; R^{G}S—; R^{G}S(O)—; R^{G}S(O)₂—; R^{G}₂P—; R^{G}₂N—; R^{G}₂C═N—; NC—; oxo (i.e., ═O), R^{G}C(O)O—; R^{G}OC(O)—; R^{G}C(O)N(R^{G})—; and R^{G}₂NC(O)—, wherein each R^{G} independently is a hydrogen atom or an unsubstituted (C₁-C₁₈)alkyl and each R^{V} independently is a hydrogen atom, an unsubstituted (C₁-C₁₈)alkyl, or an unsubstituted (C₁-C₁₈)alkoxy. The term “halo” means fluoro, chloro, bromo, or iodo; or in some embodiments in order of increasing preference chloro; bromo or iodo; chloro or bromo; or chloro. The term “heteroatom” means O, S, S(O), S(O)₂, or N(R^{N}); wherein each R^{N} independently is unsubstituted (C₁-C₁₈)hydrocarbyl or R^{N} absent (when N comprises —N═).

Certain unsubstituted chemical groups or molecules are described herein as having a practical upper limit of 20 carbon atoms (e.g., (C₂-C₂₀)hydrocarbylene), but the present invention contemplates such unsubstituted chemical groups or molecules having a maximum number of carbon atoms that is lower or higher than 20 (e.g., 6, 10, 40, 60, 100, 1,000, or >1,000). In some embodiments, each unsubstituted chemical group and each substituted chemical group has a maximum of 15; 12; 6; or 4 carbon atoms.

Preferably, the enhanced PAMOF of the first or sixth embodiment independently is a partially-aminated zinc-organic framework, and more preferably a partially-aminated zinc-terephthalate framework.

The enhanced PAMOF defines a plurality of pores and comprises a plurality of the metal cations, the amino-substituted derivative of the multi-carboxylic acid and multi-carboxylic acid, or the acceptable salts thereof, or any combination thereof. Typically upon crystallization from the dispersion medium during the invention process, the pores of the enhanced PAMOF are initially blocked or filled by, and thus the enhanced PAMOF further comprises, the dispersion medium, which is removable therefrom. Thus, the enhanced PAMOF is initially characterizable as being a blocked-pore form of the enhanced PAMOF, which is not characterizable by the synergistic CO₂ gas sorption effect. In some embodiments the process further comprises a step of removing the dispersion medium from the pores of the blocked-pore form of the enhanced PAMOF so as to give the active-pore form of the enhanced PAMOF, which is characterizable by the synergistic CO₂ gas sorption effect or total pore volume effect. In some embodiments the enhanced PAMOF (e.g., an enhanced partially-aminated zinc-terephthalate framework) is characterizable by the synergistic CO₂ gas sorption effect, in other embodiments by the total pore volume effect, and in still other embodiments by both effects.

As mentioned before, the synergistically effective ratio of the enhanced PAMOF preferably is expressed as a synergistically effective molar ratio or range thereof. The synergistically effective molar ratio is equal to the starting molar ratio of the multi-carboxylic/carboxylate species to amino-substituted multi-carboxylic/carboxylate species (e.g., total moles of terephthalic/terephthalate species to total moles of amino-substituted terephthalic/terephthalate species) used to prepare the enhanced PAMOF, assuming 100% incorporation of the amino-substituted terephthalic/terephthalate species. The starting molar ratio is also referred to herein as the “expected molar ratio.” In a particular sample of the enhanced PAMOF, the ratio of molar amounts of such species actually incorporated therein (actual molar ratio of total moles of amino-substituted terephthalic/terephthalate species to total moles of terephthalic/terephthalate species), as determined experimentally (e.g., based on elemental analysis, preferably C,H,N combustion analysis), theoretically could be different than the expected molar ratio. The actual molar ratio of the multi-carboxylic/carboxylate species to amino-substituted multi-carboxylic/carboxylate species in the enhanced PAMOF is not expected to be significantly different (i.e., >10%) than the starting molar ratio when averaged over n repeat experiments (e.g., for n≧3.). If there is any difference, the average difference is expected to be preferably <10%, preferably <5%, more preferably <2%, and still more preferably <1%. If desired, such synergistically effective molar ratio and any such difference could be readily determined by determining the actual molar ratio based on elemental analysis of the enhanced PAMOF itself. If there is any difference between the expected molar ratio (based on the starting molar ratio) and the actual molar ratio of total moles of amino-substituted terephthalic/terephthalate species to total moles of terephthalic/terephthalate species based on elemental analysis (preferably C,H,N combustion analysis), then the synergistically effective molar ratio or range thereof is based on the actual molar ratio. If desired, the enhanced PAMOF can be derivatized for elemental analysis by immersing the active-pore form of the enhanced PAMOF in, and thereby infusing its pores with, a chloroform solution of an excess amount of an amine derivatizing agent in such a way so as to derivatize all of the —NH₂ moieties of the —R—NH₂ groups therewith; removing the chloroform and excess amine derivatizing agent (e.g., by evaporation); and subjecting the resulting dried amino-derivatized enhanced PAMOF to elemental analysis. Examples of the amine derivatizing agent are trimethylsilylchloride/pyridine and N,O-bis(trimethylsilyl)trifluoroacetamide/pyridine, both useful for converting —NH₂ moieties to —N(H)-trimethylsilyl groups. Elemental analysis for C, H, and N is determined by standard combustion method, e.g., with a 2400 CHN/O Analyzer from PerkinElmer Inc. Waltham, Mass., USA. Metal (e.g., zinc) content is determined by Inductively Coupled Plasma-Optical Emission Spectroscopy (ICP-OES), also known as Inductively Coupled Plasma-Atomic Emission Spectroscopy (ICP-AES), e.g., with an Optima 7000 DV ICP-OES from PerkinElmer. Powder x-ray diffraction (PXRD) can be used to determine bulk structure of the enhanced PAMOF, e.g., with a Bruker D8 Advance x-ray diffractometer (Bruker AXS Inc., Madison, Wis. USA).

The metal cations can be obtained from any metal salt that does not prevent formation of the enhanced PAMOF. In some embodiments the metal salt is an organic metal salt wherein the organic component is an anion of a (C₁-C₁₁)carboxylic acid. Examples of suitable (C₁-C₁₁)carboxylic acids are metal formate, metal acetate, metal propionate, metal butyrate, metal oxalate, metal citrate, metal terephthalate, and metal amino-substituted terephthalates (e.g., zinc 2-aminoterephthalate). More preferably, the metal salt is an inorganic metal salt. Examples of suitable inorganic metal salts are metal halide, metal sulfate, metal phosphate, and metal nitrate, with metal nitrate (e.g., zinc nitrate hexahydrate) being preferred. The term “halide” means fluoride, chloride, bromide or iodide, with chloride being preferred. The metal salts includes hydrates and solvates thereof and hemi metal salts (e.g., zinc bis(terephthalic acid monoanion and zinc monoacetate mononitrate) and full metal salts (e.g., zinc terephthalic acid dianion and Zn(NO₃)₂. Many suitable metal salts can be purchased from commercial sources such as, for example, Sigma-Aldrich Company, St. Louis, Mo., USA.

Each metal atom(s) of the metal salt, and each of the metal atoms of the metal cluster, preferably independently is a metal of Group 1, in other embodiments Group 2, in other embodiments Group 3, in other embodiments Group 4, in other embodiments Group 5, in other embodiments Group 6, in other embodiments Group 7, in other embodiments Group 8, in other embodiments Group 9, in other embodiments Group 10, in other embodiments Group 11, in other embodiments Group 12, in other embodiments Group 13, in other embodiments Group 14, in other embodiments Group 15 and in other embodiments Group 16. More preferably each metal atom(s) of the metal salt, and each of the metal atoms of the metal cluster, preferably independently is any one of scandium, titanium, vanadium, chromium, manganese, magnesium, cobalt, iron, nickel, copper, zinc, yttrium, zirconium, niobium, molybdenum, ruthenium, rhodium, palladium, silver, cadmium, lanthanum, hafnium, tantalum, tungsten, rhenium, osmium, iridium, gold, aluminum, indium, lead, tin, gallium, and germanium. Still more preferably, each of the remaining metal atom(s) independently is aluminum, indium, nickel, or zinc, or a combination of at least any two thereof. In some embodiments each metal atom of the metal salt or metal cluster is zinc. The metal cluster can be naked, that is, without ligands other than the organic polydentate anions, or can further include a monodentate ligand. Preferably the metal salt is a zinc salt and the metal cation is a zinc cation.

In some embodiments the multi-carboxylic acid is not a terephthalic acid and the amino-substituted derivative of the multi-carboxylic acid is not an amino-substituted terephthalic acid. More preferably, the multi-carboxylic acid is terephthalic acid and the amino-substituted derivative of the multi-carboxylic acid is an amino-substituted terephthalic acid. The term “amino-substituted terephthalic acid” means a compound of formula (ATPA):

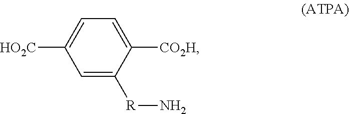

wherein each R independently is (C₁-C₃)alkylene or, preferably, is absent. The term “amino-substituted terephthalate anion” means a compound of formula (ATMA1), (ATMA2) or (ATDA):

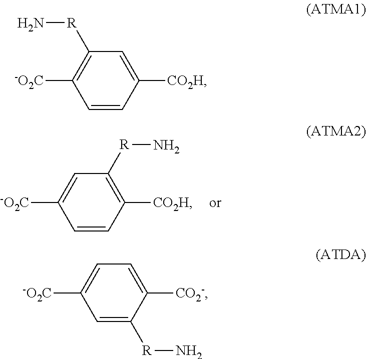

wherein each R independently is (C₁-C₃)alkylene or, preferably, is absent. Typically, the compounds of formulas (ATPA), (ATMA1), (ATMA2) and (ATDA) will be in equilibrium with each other in solution. The term “terephthalic acid” means the compound of formula (TPA):

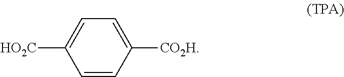 [SMILES: O=C(O)c1ccc(C(=O)O)cc1]

The term “terephthalate anion” means a compound of formula (TMA) or (TDA):

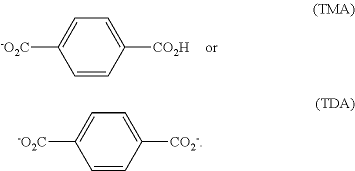

Typically, the compounds of formula (TPA), (TMA) and (TDA) will be in equilibrium with each other in solution.

In the enhanced partially-aminated metal-organic framework (enhanced PAMOF), preferably at least 90 mole percent (mol %) of the metal cations comprise zinc cations and at least 90 mol % of the multi-carboxylic/carboxylate species comprise the terephthalic/terephthalate species and at least 90 mol % amino-substituted derivative multi-carboxylic/carboxylate species comprise the amino-substituted terephthalic/terephthalate species, as determined by amounts of metal salt and sources of multi-carboxylic/carboxylate species and amino-substituted derivative multi-carboxylic/carboxylate species used to prepare the enhanced PAMOF.

In a preferred aspect of the second embodiment the present invention provides the process for making the enhanced partially-aminated metal-organic framework, the process comprising contacting in the dispersion medium a zinc salt with a synergistically effective ratio of an amino-substituted terephthalic acid, or acceptable salt thereof (collectively referred to as amino-substituted terephthalic/terephthalate species), and terephthalic acid, or acceptable salt thereof (collectively referred to as terephthalic/terephthalate species), or any combination thereof, and allowing the enhanced partially-aminated metal-organic framework to form and crystallize therefrom, wherein the enhanced partially-aminated metal-organic framework is an enhanced partially-aminated zinc-terephthalate framework that defines a plurality of pores. Typically, the enhanced partially-aminated zinc-terephthalate framework (enhanced PAMOF^{ZT}) comprises a plurality of zinc cations of the zinc salt; molecules of the terephthalic acid and an amino-substituted terephthalic acid, or the acceptable salts thereof, or any combination thereof; and a charge neutralizing number of anions of the zinc salt such that the enhanced PAMOF^{ZT} is formally neutral. Typically upon crystallization from the dispersion medium, the pores of the enhanced PAMOF^{ZT} are initially blocked or filled by, and thus the enhanced PAMOF^{ZT} further comprises, the dispersion medium, which is removable therefrom. Thus, the enhanced PAMOF^{ZT} is initially characterizable as being in a blocked-pore form. In some embodiments the process further comprises a step of removing the dispersion medium from the pores of the blocked-pore form of the enhanced PAMOF^{ZT} so as to give an active-pore form of the enhanced PAMOF^{ZT}, which is characterizable by the synergistic CO₂ gas sorption effect.

In a preferred aspect of the first or third embodiment, the present invention provides the enhanced PAMOF^{ZT}.

In a preferred aspect of the fourth embodiment, the present invention provides a manufactured article comprising the enhanced PAMOF^{ZT}.

In a preferred aspect of the fifth embodiment, the present invention provides a separation method of separating an acid gas from a separable gas mixture comprising the acid gas and at least one adsorption-resistant gas, the method comprising contacting the active-pore form of the enhanced PAMOF^{ZT} with the separable gas mixture; allowing the acid gas of the separable gas mixture to penetrate into the pores of, and adsorb onto, the enhanced PAMOF^{ZT}; and removing an enriched adsorption-resistant gas portion of the separable gas mixture from the enhanced PAMOF^{ZT}, wherein the enriched adsorption-resistant gas portion of the separable gas mixture has a lower concentration of the acid gas than does the separable gas mixture. The separation method separates at least some of at least one acid gas from the separable gas mixture. Preferably, the acid gas is carbon dioxide (CO₂) gas.

For convenience, the terephthalic acid and terephthalate anions (of the acceptable salt of terephthalic acid) are collectively referred to herein as “terephthalic/terephthalate species.” For convenience, the amino-substituted terephthalic acid and amino-substituted terephthalate anions (of the acceptable salt of amino-substituted terephthalic acid) are collectively referred to herein as “amino-substituted terephthalic/terephthalate species.”

In some embodiments the enhanced PAMOF^{ZT} consists essentially of, or is prepared from ingredients consisting essentially of, the zinc cations and the synergistically effective ratio of amino-substituted terephthalic/terephthalate species to terephthalic/terephthalate species.

The synergistically effective ratio of the amino-substituted terephthalic/terephthalate species to terephthalic/terephthalate species can be readily observed by measuring the synergistic CO₂ gas sorption effect of the enhanced PAMOF^{ZT} according to the CO₂ gas sorption method described later. In some embodiments the synergistically effective ratio of the amino-substituted terephthalic/terephthalate species to the terephthalic/terephthalate species is a synergistically effective molar ratio of from >0 to <3:1 based on the CO₂ gas sorption and total starting moles of the amino-substituted terephthalic/terephthalate species to total starting moles of the terephthalic/terephthalate species used to prepare the enhanced PAMOF^{ZT}. In some embodiments the synergistically effective molar ratio is from 10:90 to 65:35, i.e., the amino-substituted terephthalic/terephthalate species are from 10 mole percent to 65 mole percent of the total number of moles of the amino-substituted terephthalic/terephthalate species plus terephthalic/terephthalate species. In some embodiments the synergistically effective molar ratio is at least 15:85 or at least 20:80. In some embodiments the synergistically effective molar ratio is at most 60:40 or at most 55:45. In some embodiments the synergistically effective molar ratio is from about 25:75 to about 50:50 or from 25:75 to 50:50.

Alternatively, the synergistically effective ratio of the amino-substituted terephthalic/terephthalate species to terephthalic/terephthalate species can be readily observed by measuring the synergistic total pore volume effect of the enhanced PAMOF^{ZT} according to the total pore volume method ASTM D4222-03 (2008) described later. Total pore volume is positively correlated to CO₂ gas sorption capacity, catalyst metal supporting capacity (for the heterogeneous metal catalyst), or both. Increasing total pore volume of the enhanced PAMOF^{ZT} gives increasing CO₂ gas sorption capacity of the enhanced PAMOF^{ZT}, increasing catalyst metal supporting capacity of the enhanced PAMOF^{ZT}, or both. A synergistic total pore volume effect is a total pore volume >0.12 cubic centimeters per gram (cm³/g) of MOF (e.g., enhanced PAMOF^{ZT}), preferably >0.23 cm³/g, more preferably >0.29 cm³/g, and still more preferably >0.30 cm³/g. In some embodiments the synergistically effective ratio of the amino-substituted terephthalic/terephthalate species to the terephthalic/terephthalate species is a synergistically effective molar ratio of from ≧0.35:0.65 to ≦3:1 based on the total pore volume and total starting moles, and assuming 100% (complete) incorporation, of the amino-substituted terephthalic/terephthalate species to total starting moles (expected molar ratio) of the terephthalic/terephthalate species used to prepare the enhanced PAMOF^{ZT}. In some embodiments such synergistically effective molar ratio is from 50:50 to 65:35.

Alternatively, the synergistically effective ratio of the amino-substituted terephthalic/terephthalate species to terephthalic/terephthalate species can be readily observed by measuring the synergistic total pore volume effect of the enhanced PAMOF^{ZT} according to the total pore volume method ASTM D4222-03 (2008) described later and determining the actual molar ratio of total moles of amino-substituted terephthalic/terephthalate species to total moles of terephthalic/terephthalate species based on elemental analysis, preferably C,H,N combustion analysis. In some embodiments the synergistically effective molar ratio based on such total pore volume and actual molar ratios is from 30:70 to 70:30, i.e., the amino-substituted terephthalic/terephthalate species are from 30 mole percent to 70 mole percent of the total number of moles of the amino-substituted terephthalic/terephthalate species plus terephthalic/terephthalate species based on elemental analysis, preferably C,H,N combustion analysis. In some embodiments such synergistically effective molar ratio is at least 35:65; and in other embodiments at least 40:60; or in other embodiments at most 65:35; and in other embodiments at most 60:40; in still other embodiments from about 35:65 to about 65:35; and in still other embodiments from 37:63 to 62:38, all based on such total pore volume and actual molar ratios based on elemental analysis, preferably C,H,N combustion analysis.

The present invention includes enhanced PAMOF^{ZT} according to any one, and preferably at least two, of the aforementioned synergistic effects.

The enhanced PAMOF^{ZT} preferably is prepared from a molar ratio of moles of the zinc cations to moles of the terephthalic/terephthalate species of from 19:1 to 2:1, more preferably from 12:1 to 7:3, still more preferably from 7:1 to 4:1, and even more preferably from 85:15 to 4:1 (e.g., 82:18).

Characterization of the structure of the enhanced PAMOF shows that it defines a three-dimensional matrix defining the aforementioned plurality of pores (voids). Without being bound by theory, in the enhanced PAMOF, the amino-substituted multi-carboxylic/carboxylate species and multi-carboxylic/carboxylate species are believed to function as linkers between at least two different ones of the metal cations, which together form the three-dimensional matrix. The three-dimensional matrix has a plurality of nodes comprising the metal cations. Preferably, each node of the matrix independently is a metal cluster or comprises a single metal cation. The invention contemplates enhanced PAMOFs having a combination of such nodes. In some embodiments every node of the matrix is the metal cluster and in other embodiments every node comprises the single metal cation. In some embodiments the metal cluster is a Zn₄O cluster.

In some embodiments the metal salt is an organic zinc salt wherein the organic component is an anion of a (C₁-C₁₁)carboxylic acid. Examples of organic zinc salts with suitable (C₁-C₁₁)carboxylic acids are zinc formate, zinc acetate, zinc propionate, zinc butyrate, zinc oxalate, zinc citrate, zinc terephthalate, and zinc amino-substituted terephthalates (e.g., zinc 2-aminoterephthalate). More preferably, the zinc salt is an inorganic zinc salt. Examples of suitable inorganic zinc salts are zinc halide, zinc sulfate, zinc phosphate, and zinc nitrate, with zinc nitrate (e.g., zinc nitrate hexahydrate) being preferred. The zinc salts includes hydrates and solvates thereof and hemi zinc salts (e.g., zinc bis(terephthalic acid monoanion and zinc monoacetate mononitrate) and full zinc salts (e.g., zinc terephthalic acid dianion and Zn(NO₃)₂. Suitable zinc salts can be purchased from commercial sources such as, for example, Sigma-Aldrich Company, St. Louis, Mo., USA.

In some embodiments of the amino-substituted derivative of the multi-carboxylic acid or the anionic forms thereof, including the amino-substituted terephthalic acid or amino-substituted terephthalate, every R is absent. When R is absent, —R—NH₂ is —NH₂. In some embodiments at least one R, and in other embodiments every R, is (C₁-C₃)alkylene. Preferably, at least one, and more preferably each, (C₁-C₃)alkylene is CH₂ (i.e., —R—NH₂ is —CH₂NH₂).

The anionic forms of the multi-carboxylic acid, including the terephthalate and amino-substituted terephthalate anions, can be derived from their corresponding multi-carboxylic acid and amino-substituted derivative of the multi-carboxylic acid, including the terephthalic acid and amino-substituted terephthalic acid, by reaction with a suitable base. In some embodiments the base is an organic base, and more preferably a (C₁-C₄)alkoxide of a metal of any one of Groups 1 to 13 of the Periodic Table of the Elements. Preferably, the base is an inorganic base. Preferably, the inorganic base is a hydroxide, bicarbonate, or carbonate of a metal of any one of Groups 1 and 2 of the Periodic Table of the Elements. Thus, the acceptable salt of the multi-carboxylic acid and amino-substituted derivative of the multi-carboxylic acid includes a substance comprising the metal of any one of Groups 1 to 13, preferably, the metal of Group 1 or 2, and the anionic forms thereof. Conversely, the multi-carboxylic acid and the amino-substituted derivative of the multi-carboxylic acid can be derived from their corresponding anionic forms by reaction with a suitable acid. In some embodiments the acid is a Brønsted acid. In some embodiments the Brønsted acid is an (C₁-C₁₂) organic protic acid (e.g., formic acid, acetic acid or benzoic acid). Preferably, the Brønsted acid is an inorganic protic acid. Examples of suitable inorganic protic acids are hydrochloric acid, hydrogen chloride, sulfuric acid, sulfinic acid, nitric acid, and phosphoric acid. The combination of multi-carboxylic acid, amino-substituted derivative of the multi-carboxylic acid, multi-carboxylate salt, and amino-substituted derivative of the multi-carboxylate salt can be prepared by contacting in water or a polar organic solvent (e.g., dimethylformamide or methanol) the multi-carboxylic acid and amino-substituted derivative of the multi-carboxylic acid to an amount of the suitable base that is effective for producing the combination.

For convenience, the blocked-pore forms of the enhanced PAMOF are designated herein as “BPF-enhanced PAMOF” and active-pore forms of the enhanced PAMOF are designated herein as “APF-enhanced PAMOF”. Use of the generic acronym enhanced PAMOF includes the BPF-enhanced PAMOF and APF-enhanced PAMOF.

In a general procedure, the enhanced PAMOF can be prepared by mixing in a dispersion medium (e.g., N,N-dimethylformamide (DMF) or N,N-diethylformamide (DEF)) reactants comprising the multi-carboxylic acid and amino-substituted derivative of the multi-carboxylic acid, or the acceptable salts thereof, or the combination thereof and the metal salt in the aforementioned molar ratios thereof, seal the resulting mixture in a vessel, and heat the mixture to a dissolution/reaction/crystallization temperature sufficient to dissolve the reactants (e.g., a temperature of from 50° C. to 150° C., e.g., 100° C.) for a reaction and crystallization period of time of from 1 hour to 1 week (e.g., 36 hours) to form and crystallize the enhanced PAMOF in the dispersion medium to give crystal(s) of a first BPF-enhanced PAMOF. Cool the resulting mixture to ambient temperature (e.g., 20° C.), and decant or remove excess (all) of dispersion medium away from the first BPF-enhanced PAMOF crystal(s). Immerse the first BPF-enhanced PAMOF crystal(s) in a volatile solvent (e.g., aprotic solvent, e.g., chloroform) for the dispersion medium, and allow the resulting mixture to stand at ambient temperature for a diffusion period of time of from 1 hour to 1 month (e.g., 3 days) so as to diffuse dispersion medium (e.g., DMF) out of the pores of the first BPF-enhanced PAMOF crystal(s) and replace it with the volatile solvent (e.g., CHCl₃) so as to give an intermediate that is a second BPF-enhanced PAMOF. Decant excess volatile solvent away from the second BPF-enhanced PAMOF. Dry the residual second BPF-enhanced PAMOF under vacuum, optionally first at ambient temperature for a brief period of time (e.g., from 30 minutes to 6 hours), then heat the crystals under vacuum to a suitable drying temperature (e.g., first to 50° C. for a period of time of from 1 hour to 1 day (e.g., 18 hours), and then to a drying temperature of from 200° C. to 300° C. (e.g., 250° C.) for a drying period of time of from 1 hour to 1 day (e.g., 18 hours) to give an APF-enhanced PAMOF. A typical amount of the dispersion medium would be a volume sufficient to dissolve all of the reactants at the dissolution/reaction/crystallization temperature and give a solution of metal salt at a concentration of from about 0.10 molar (M) to about 0.12 M.

Each pore of the enhanced PAMOF independently can be in the form that is open to receiving an acid gas molecule and functionally-disposed for adhering thereto (active-pore form) or in the form that is blocked (e.g., by removable molecule(s) as described later) from receiving the acid gas molecule (blocked-pore form). That is, each node of the three-dimensional matrix of the structure of the enhanced PAMOF independently can have an open binding site for bonding to an acid gas molecule or the binding site can be blocked from bonding thereto. The overall or average degree of activeness of the pores of the enhanced PAMOF to receiving acid gas molecules is believed to depend upon the overall or average presence of absence of removable solid or liquid molecules in the pores of the enhanced PAMOF. Preferably, the enhanced PAMOF contains a sufficient amount of open binding sites so as to exhibit a synergistic acid gas sorption effect. The average degree of activeness of the pores of the enhanced PAMOF and synergistic CO₂ gas sorption effect can be determined by a CO₂ gas sorption experiment, as described later.

Upon crystallization of the enhanced PAMOF, the solid or liquid substance in the pores of the enhanced PAMOF includes the dispersion medium, and the pores of the enhanced PAMOF are typically blocked or filled by the dispersion medium such that the newly synthesized enhanced PAMOF can be characterized as being the BPF-enhanced PAMOF. Examples of the dispersion medium are a solvent or a space-filling agent. Sometimes the space-filling agent is called or functions as a templating agent or structure directing agent. An example of the space-filling agent is an inert porous structure (e.g., a porous organic polymer structure) that can be used as a template around which the three-dimensional matrix of the preferred enhanced PAMOF can crystallize. The dispersion medium is an example of removable solid or liquid molecules that can be called “guest molecules.” Guest molecules are residual compounds (e.g., solvent molecules) that are not a part of the structure of the enhanced PAMOF. In addition to the dispersion medium, additional examples of the guest molecules is a volatile solvent that is allowed to diffuse into the pores of the enhanced PAMOF and displace a non-volatile solvent therefrom. In addition to guest molecules, additional examples of the removable solid or liquid molecules that can block or fill the pores of the enhanced PAMOF are charge balancing species. The charge balancing species counteracts any unbalanced charges of the metal cation or amino-substituted derivative of the multi-carboxylic/carboxylate species and amino-multi-carboxylic/carboxylate species or both so that the enhanced PAMOF is overall neutral. An example of the charge balancing species is a non-linking ligand, which can bond or coordinate to one of the metal cations of the enhanced PAMOF, but does not link together two metal cations. If the charge-balancing species is small enough so as to not block the pores of the enhanced PAMOF, the enhanced PAMOF is an APF-enhanced PAMOF, and the small charge-balancing species optionally can be removed from or left in the APF-enhanced PAMOF. The pores of the BPF-enhanced PAMOF can also be blocked or filled with a combination of two or more removable solid or liquid molecules. The BPF-enhanced PAMOF can be, and preferably is, activated to give the APF-enhanced PAMOF. The BPF-enhanced PAMOF preferably is activated by removing the solid or liquid molecules from the pores thereof. The removable solid or liquid molecules can be removed from the pores of the BPF-enhanced PAMOF by any suitable means such as evaporation, extraction (diffusion) with the lower boiling solvent followed by evaporation, or decomposition or partial decomposition with removal of extractable (diffusible) or volatile (partial) decomposition products, or a combination of at least two thereof so as to yield the APF-enhanced PAMOF while leaving the structure of the enhanced PAMOF substantially unchanged. For example, volatile guest molecules can be removed by evaporation or drying, which can comprise heating of, application of a vacuum source to, or both a BPF-enhanced PAMOF containing volatile removable molecules therein so as to give a dried APF-enhanced PAMOF. The active pores of the dried APF-enhanced PAMOF are occupied by gas (e.g., air or inert gas such as a gas of nitrogen, helium or argon) or under vacuum. Non-volatile guest molecules can be removed from a BPF-enhanced PAMOF containing same by extraction (diffusion) thereof with the volatile solvent, which replaces the non-volatile guest molecules to give a first intermediate BPF-enhanced PAMOF containing the volatile solvent in its pores, and then the volatile solvent is removed from the first intermediate BPF-enhanced PAMOF by evaporation or drying as described previously to give an APF-enhanced PAMOF. The space-filling agent, charge balancing species, or at least a portion thereof, can be removed from the pores of a BPF-enhanced PAMOF containing the space-filling agent, charge balancing species, or a combination thereof by a process comprising subjecting the space-filling agent, charge balancing species, or combination thereof to decompositionally effective conditions in situ in such a way so as to produce a second intermediate BPF-enhanced PAMOF containing removable (partial) decomposition products in its pores; and removing the removable (partial) decomposition products from the second intermediate BPF-enhanced PAMOF to give the APF-enhanced PAMOF. Partial decomposition of the charge balancing species typically gives a smaller charge balancing species (e.g., H⁺). Preferably, the decompositionally effective conditions comprise thermal degradation of the at least portion of the space-filling agent, charge balancing species, or the combination thereof to give gaseous (partial) decomposition products. An example of thermal degradation can be heat-promoted molecular fragmentation or selective oxidation of the space-filling agent, charge balancing species, or the combination thereof while leaving the structure of the enhanced PAMOF substantially unchanged.

The structure of the invention enhanced PAMOF, including the APF-enhanced PAMOF and BPF-enhanced PAMOF, can be characterized by Brunauer-Emmett-Teller (BET) surface area, CO₂ gas sorption, elemental analysis, PXRD, thermogravimetric analysis (TGA), or a combination of at least two thereof. Preferably, the characterization comprises a combination of PXRD, CO₂ gas sorption, and elemental analysis methods. At least some of these analytical methods are described later. For example, the pores of the enhanced PAMOF can be characterized as having an average pore diameter or, preferably, total pore volume. Total pore volume is preferably determined by ASTM D4222-03 (2008), Standard Test Method for Determination of Nitrogen Adsorption and Desorption Isotherms of Catalysts and Catalyst Carriers by Static Volumetric Measurements. Average pore diameter is preferably determined by ASTM D4641-94 (2006), Standard Practice for Calculation of Pore Size Distributions of Catalysts from Nitrogen Desorption Isotherms. Preferably, the average pore diameter for the three-dimensional matrix is from 1 Ångstrom to 20 Ångstroms, in other embodiments from 3 Ångstroms to 18 Ångstroms, and in other embodiments from 10 Ångstroms to 12 Ångstroms. In the unoccupied enhanced PAMOF, its pores are sufficiently unoccupied and its metal cations or cluster thereof have an accessible site so as to accommodate coordinating of CO₂ gas molecules to the metal cations in the pores.

Typically, the APF-enhanced PAMOF is characterizable as having a high BET surface area. In some embodiments the BET surface area of the APF-enhanced PAMOF is from 300 square meters per gram (m²/g) to 10,000 m²/g, in other embodiments from 1,000 m²/g to 5,000 m²/g, and in other embodiments from 2,000 m²/g to 3,000 m²/g. Preferably, the APF-enhanced PAMOF is useful for storing or collecting CO₂ gas therein. Without wishing to be bound by theory, it is believed that CO₂ gas molecules adsorb onto surfaces of the APF-enhanced PAMOF. The surfaces can be exterior, interior, or both exterior and interior surfaces. All other factors being equal, the higher the BET surface area of the APF-enhanced PAMOF, the better the APF-enhanced PAMOF is for CO₂ gas sorption. It is believed that the APF-enhanced PAMOF is selective for preferentially adsorbing CO₂ gas molecules more than the APF-enhanced PAMOF would adsorb molecules of a gas of hydrogen (H₂), a gaseous hydrocarbon (e.g., methane (CH₄), ethane, ethene, propane, propene, butane, or butene), or an inert gas of nitrogen (N₂), helium (He), or argon (Ar). The term “gas” means a substance that is a non-liquid fluid at 20° C. It is believed that the APF-enhanced PAMOF is also selective for preferentially adsorbing CO₂ gas molecules more than the APF-enhanced PAMOF would adsorb molecules of a vapor of water (H₂O).

Preferably, the active pores of the APF-enhanced PAMOF allow permeant gas molecules, more preferably at least CO₂ gas molecules, to enter thereinto (e.g., by diffusion from a process stream) and reversibly adsorb to the APF-enhanced PAMOF to give a CO₂ gas-APF-enhanced PAMOF composition (e.g., wherein the CO₂ gas is sequestered by the APF-enhanced PAMOF to reduce greenhouse gas emissions). The present invention also provides the CO₂ gas-partially-aminated metal-organic framework composition. Examples of conditions that favor CO₂ gas molecule adsorption are the CO₂ gas separation conditions of temperature and pressure described later. If desired, the adsorbed CO₂ gas molecules can be liberated from the CO₂ gas-APF-enhanced PAMOF composition by employing conditions that favor reversal of their adsorption. Examples of conditions that favor reversal of CO₂ gas molecule adsorption (desorption) are vacuum swing or temperature swing adsorption conditions wherein temperature is sufficiently increased, pressure is sufficiently decreased, or preferably both such that the conditions are effective for CO₂ desorption (e.g., temperature >200° C. and pressure <1 kPa). Examples of circumstances where it would be desirable to liberate the adsorbed CO₂ gas are use of the CO₂ gas-APF-enhanced PAMOF composition in a beverage container to carbonate a beverage (e.g., beer) disposed therein or use of the CO₂ gas-APF-enhanced PAMOF composition as a source of CO₂ gas for preparing dry ice or a CO₂ supercritical fluid or wherein the CO₂ gas serves as reactant in a synthesis or an organic compound (e.g., a carboxylic acid) or polymer (e.g., polycarbonate).

The separable gas mixture can comprise at least one acid gas. Preferably, the acid gas comprises a carbon oxide gas, carbon sulfide gas, carbon oxide sulfide gas, nitrogen oxide gas, sulfur oxide gas, hydrogen sulfide gas (H₂S (g)), or a hydrogen halide gas (or vapor). In some embodiments the acid gas comprises a gas of carbon monoxide (CO); carbon dioxide (CO₂); carbon disulfide (CS₂); nitrous oxide (N₂O); nitric oxide (NO); nitrogen dioxide (NO₂); dinitrogen trioxide (N₂O₃); dinitrogen tetroxide (N₂O₄); dinitrogen pentoxide (N₂O₅); sulfur oxide (SO); sulfur dioxide (SO₂); sulfur trioxide (SO₃); H₂S, hydrogen fluoride (HF); or hydrogen chloride (HCl). More preferred is SO₂ gas or CO₂ gas, and still more preferred is CO₂ gas.

The enriched adsorption-resistant gas portion can comprise at least one adsorption-resistant gas (and, in some embodiments, a remainder of an acid gas). Examples of preferred adsorption-resistant gases are non-acid gases such as a gas of methane (CH₄), ethane (CH₃CH₃), propane (CH₃CH₂CH₃), butane (CH₃CH₂CH₂CH₃), hydrogen (H₂), nitrogen (N₂), a noble element, a non-acidic component of air (e.g., N₂ gas and noble gas), or a non-acidic component of flue (e.g., N₂ gas) or natural gas (e.g., N₂ gas and CH₄ gas). Preferably, the noble element gas is argon (Ar) gas.

Preferably, the APF-enhanced PAMOF is employed in an embodiment of the separation method for CO₂ gas separation. In such embodiments the separation method produces from the separable gas mixture and the APF-enhanced PAMOF the CO₂ gas-APF-enhanced PAMOF composition and the enriched adsorption-resistant gas portion. The enriched adsorption-resistant gas portion can still contain some of the CO₂ gas of the separable gas mixture or, preferably, lacks CO₂ gas. Even so, the enriched adsorption-resistant gas portion has a higher concentration of the adsorption-resistant gas(es) than does the separable gas mixture and the CO₂ gas-APF-enhanced PAMOF composition has a higher concentration of adsorbed CO₂ gas than does the APF-enhanced PAMOF.

Naturally, the manufactured article contains an application effective amount (e.g., an acid gas-adsorbing effective amount) of the enhanced PAMOF for the particular application for which it is intended. The application effective amounts can be readily determined under the circumstances. For example, one could initially prepare an embodiment of the manufactured article having a high known quantity of the enhanced PAMOF and then a successive series of manufactured articles wherein each successive one has an incrementally lower known quantity of the enhanced PAMOF (e.g., quantity x, 0.8x, 0.6x, 0.4x, and 0.2x). The separation method can then be performed with the manufactured article having the highest known quantity (e.g., X) of the enhanced PAMOF. Thereafter, the other manufactured articles having incrementally lower quantities of the enhanced PAMOF can be used until a desired effect (e.g., acid gas separation effect) under the circumstances is achieved.

When used in acid gas separations, the APF-enhanced PAMOF can be used in any suitable manner such as being interposed in a feed stream of the separable gas mixture from a combustion furnace or natural gas well-head or as an active component of a house wrap or other barrier material. In some embodiments the APF-enhanced PAMOF is adapted for use in a unit operation wherein acid gas is separated from the separable gas mixture. In some embodiments the unit operation is employed downstream from a furnace or other combustion apparatus for separating acid gas from flue gas or downstream from an oil or natural gas well-head for separating acid gas from natural gas. The APF-enhanced PAMOF can be employed as a component of a separation device adapted for receiving a flow of flue gas from the combustion apparatus or natural gas from the well-head and separating at least some of the acid gas therefrom. Portions of the separation device other than the APF-enhanced PAMOF (e.g., support members and gas conduits) can comprise any material. Preferably, the portions of the separation device that can contact the flue or natural gas are resistant to decomposition by the acid gas. Examples of suitable acid gas-resistant materials are stainless steels, polyolefins (e.g., polypropylene and poly(tetrafluoroethylene)) and a HASTELLOY™ metal alloy (Haynes Stellite Corp., Kokomo, Ind., USA).

If desired, the PAMOF of the manufactured article can initially comprise the BPF-PAMOF where use of the manufactured article later comprises conversion of the BPF-PAMOF to the APF-PAMOF by displacing (e.g., evaporating or entraining) blocking molecules from the BPF-PAMOF with an effective amount of the separable gas mixture.

In some embodiments the manufactured article comprises a combustion engine containing-vehicle exhaust system comprising an acid gas-adsorbing effective amount of the enhanced PAMOF. Preferably, the combustion engine containing-vehicle is an automobile, train, watercraft, or truck having a gasoline or diesel fuel combustion engine. In other embodiments the manufactured article comprises a combustion furnace exhaust system comprising an acid gas-adsorbing effective amount of the enhanced PAMOF. An example of the combustion furnace exhaust system is an exhaust system for a coal-, oil-, natural gas-, or wood-burning furnace. In some embodiments the combustion furnace exhaust system is for use in an electricity-generating power plant. In still other embodiments the manufactured article comprises an oil or natural gas well-head vent system comprising an acid gas-adsorbing effective amount of the enhanced PAMOF. In still other embodiments the manufactured article comprises an acid gas container comprising an acid gas-adsorbing effective amount of the enhanced PAMOF. An example of the acid gas container is a carbonated-beverage container.

In some embodiments the separable gas mixture is a flue gas or natural gas. Examples of a flue gas are combustion gases produced by burning coal, oil, natural gas, wood, or a combination thereof. The invention contemplates mobile (e.g., vehicle) and stationary (e.g., furnace) applications. The natural gas can be naturally-occurring (i.e., found in nature) or manufactured. Examples of a manufactured methane gas-containing gas mixture are methane produced as a by-product from a crude oil cracking operation and biogas, which can be produced in landfills or sewage facilities from catabolism of garbage and biological waste by microorganisms.

Typically the enhanced PAMOF is in a form of a particulate material comprising a plurality of enhanced PAMOF crystals. In applications for separating an acid gas from the separable gas mixture, the enhanced PAMOF preferably is disposed in a container. The container defines an enclosed volumetric space where the enhanced PAMOF is disposed. Preferably, the container also defines at least one aperture through such that the aperture enables fluid communication between the enclosed volumetric space and a location exterior to the container. Where the container defines only one aperture, the separable gas mixture can pass into the container therethrough so that the separable gas mixture can contact the enhanced PAMOF and the resulting adsorption-resistant gas can pass out of the container therethrough. More preferably, the container has at least two apertures comprising first and second apertures. The first aperture functions in such a way that the separable gas mixture can pass into the container therethrough from a location exterior to the container to contact the enhanced PAMOF. The second aperture functions in such a way that the resulting adsorption-resistant gas can pass out of the container therethrough so as to form a sequential gas flow from the location exterior to the container, through the first aperture, into and throughout and through the enhanced PAMOF, through the second aperture, and giving a downstream flow of the adsorption-resistant gas. As used herein, the term “container” means any receptacle suitable for holding the enhanced PAMOF. Examples of suitable containers are bags (e.g., nylon-mesh bags), bottles, cans, cartons, conduit, gas filter cartridge, hose, jars, pouches, piping, reactors, sleeves, and vials. The phrase “location exterior to the container” means any position in three dimensional space that is outside of the container and in fluid communication with the aperture(s). Examples of such locations are exterior volume surrounding the container and interior space in a conduit (e.g., pipe) that is in sealed operative contact or connection to the container proximal to and around at least one of the apertures.

Regarding CO₂ gas separation conditions, the temperature of the separable gas mixture and enhanced PAMOF during the separation method (i.e., the separation temperature) can be above ambient temperature such as in natural gas or flue gas sweetening applications, at ambient temperature, or below ambient temperature such as in some natural gas sweetening applications. Preferably, the enhanced PAMOF and separable gas mixture in contact therewith independently are maintained at a separation temperature of from −50° C. to just below a highest acid gas-adsorbing effective temperature of the enhanced PAMOF. Preferably for adsorption performance, the enhanced PAMOF and separable gas mixture in contact therewith independently are maintained at a separation temperature of from −50° C. to 170° C. More preferably the separation temperature with the enhanced PAMOF is from −30° C. to 100° C., and still more preferably from −10° C. to 50° C. (e.g., 20° C. to 30° C.). Pressure of the separable gas mixture at the enhanced PAMOF can be any pressure suitable for allowing the separation method and is typically >90 kPa (e.g., 10,000 kPa or less).

### Materials and Methods

Purchase zinc nitrate hexahydrate, terephthalic acid, and 2-aminoterephthalic acid from Sigma-Aldrich Company.

Preparation of MOF samples for BET surface area and CO₂ gas sorption: add a known weight of MOF sample to be analyzed to a tared clean, dry quartz glass tube, and seal the tube with a tared seal frit (sintered glass seal).

BET surface area, total pore volume and average pore size measurement method: measure a BET surface area value and average pore size using a method in which 30% nitrogen in helium, at a P/P₀ ratio of 0.3, is adsorbed onto a test sample at liquid nitrogen temperature. In the method, use a TRISTAR 3000 BET surface area and pore size analyzer or an ASAP 2420 surface area analyzer (both Micromeritics Instrument Corporation, Norcross, Ga., USA), each having a measurement position to make the measurements. Load a test sample (e.g., the enhanced PAMOF in the frit-sealed quartz glass tube), and degas the test sample for a designated period of time at a degassing temperature such as 5 hours at 170° C. and atmospheric pressure. Place the frit-sealed quartz glass tube with sample in the measurement position of the analyzer and allow it to purge for a designated period of time such as 10 minutes. Allow nitrogen/helium gas to absorb at liquid nitrogen temperature and then desorb at room temperature to give desorption signals. Record signal readings in square meters (m²). Remove sample from the analyzer and determine its final sample mass. Divide integrated desorption signal by the final sample mass to obtain the BET surface area in square meters per gram. Repeat with two additional test samples. Average the results of the 3 runs to determine the final BET surface area, total pore volume, and average pore size.

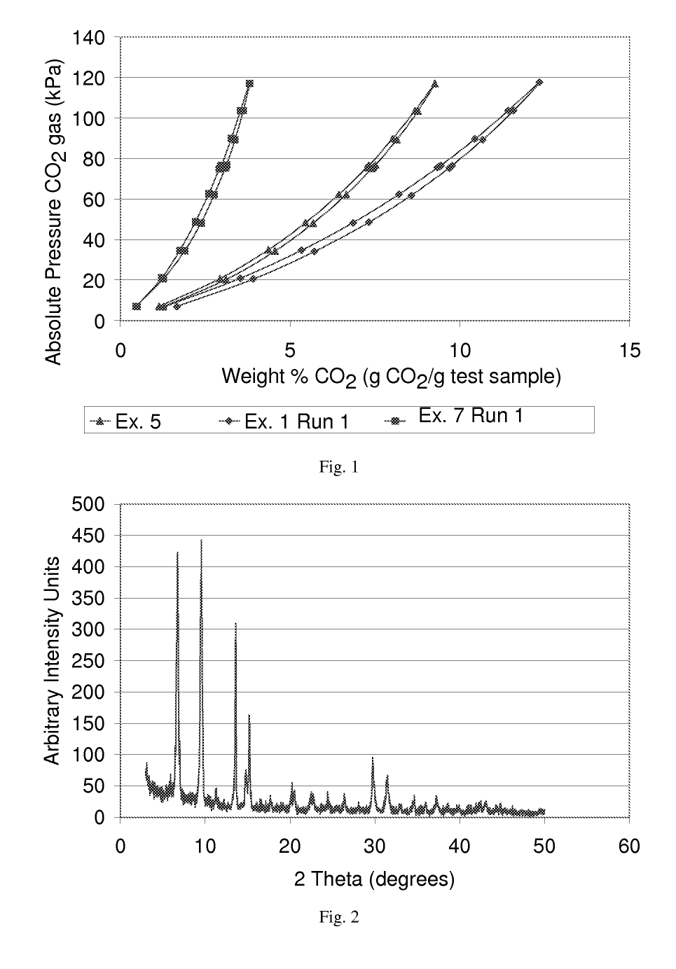

CO₂ gas sorption method: using the TRISTAR 3000 instrument and a new test sample in a new frit-sealed quartz glass tube immersed partially in 25° C. water, perform a CO₂ gas sorption analysis on the previously degassed weighed test sample by first inputting a reference pressure of Pₒ. For the examples listed the Pₒ used was 1000 Torr (133 kilopascals (kPa) of CO₂ gas. Then set up a method to automatically run on the TRISTAR 3000 at pre-set pressures of P/Pₒ For example a P/Pₒ of 0.5 corresponds to 500 Torr (67 kPa) of CO₂ gas. Generate CO₂ gas adsorption isotherms from data points at various P/Pₒ, ranging from 0.05 to 1. Increase the P/Pₒ value during the course of an isotherm run via an automatic valve the slowly increases the pressure until the P/Pₒ value reaches a designated set point within a set tolerance level of 5%. One the highest P/Pₒ setting is reached, then generate a desorption isotherm by reducing the pressure by applying vacuum via the same pressure control valve. Once the lowest P/Pₒ data point is obtained, graph the CO₂ isotherm by plotting absolute pressure of CO₂ gas in kPa versus weight percent (wt %) adsorbed CO₂ gas (grams of adsorbed CO₂ gas per gram of test sample, e.g., enhanced PAMOF or non-invention sorbent). Example graphs are shown in FIG. 1.

Elemental analysis method: determine carbon, hydrogen, and nitrogen by combustion and zinc by ICP-OES. Accuracy of each of C, H, N, and Zn is ±0.1%.

Powder x-ray diffraction (PXRD) method: examine powder by PXRD at from 3 degrees 2 theta (°2Θ) to 50 °2Θ using the Bruker D8 Advance x-ray diffractometer operated at 40 kilovolts (kV) and 40 milliamperes (mA) with divergent slit set at 0.20 and anti-scattering slit set at 0.25.

### COMPARATIVE EXAMPLE(S)

### Non-Invention

Comparative Example(s) are provided herein as a contrast to certain embodiments of the present invention and are not meant to be construed as being prior art.

### Comparative Example A

preparation of 100 mol % zinc-terephthalate acid framework (i.e., 0 mol %-aminated). Repeat the procedure of Example 1 described later two times except each time omit the 1.50 g (0.00828 mol) of 2-aminoterephthalic acid and increase the amount of terephthalic acid to 2.76 g (0.0166 mol) to give two lots of the 100 mol % zinc-terephthalate acid framework. Determine total pore volume to be 0.15 cm³/g (average of 0.122 cm³/g and 0.17 cm³/g) using the procedure of ASTM D4222-03 (2008).

### Comparative Example B

preparation of 100 mol %-aminated zinc-terephthalate acid framework (i.e., 0 mol % zinc-terephthalate acid). Repeat the procedure of Example 1 described later two times except each time omit the 1.38 g (0.00831 mol) of terephthalic acid and increase the amount of 2-aminoterephthalic acid to 3.01 g (0.0166 mol) to give two lots of the 100 mol %-aminated zinc-terephthalate acid framework. Determine total pore volume to be 0.12 cm³/g (average of 0.004 cm³/g and 0.23 cm³/g) using the procedure of ASTM D4222-03 (2008).

Some embodiments of the invention are described in more detail in the following Examples.

### Example 1

preparations of aminated (—NH₂) zinc-terephthalate acid framework (50 mole percent-aminated based on starting/expected molar ratio). Runs 1 and 2: repeat the following procedure two times: Use a 50:50 molar ratio of 2-aminoterephthalic acid to terephthalic acid. Mix 13.64 g (0.0459 mol) of Zn(NO₃)₂.6H₂O, 1.38 g (0.00831 mol) terephthalic acid, and 1.50 g (0.00828 mol) 2-aminoterephthalic acid in 400 milliliters (mL) of DMF solvent in a 1000 mL glass vessel, seal the vessel, and heat contents to 100° C. for 36 hours. Cool contents to 20° C., and decant excess DMF. Rinse remaining crystals with additional DMF, decanting excess DMF to give a blocked-pore form of 50 mole percent-aminated zinc-terephthalate acid framework. Immerse remaining crystals in chloroform, seal in vessel, and allow to stand at 20° C. for 3 days. Decant chloroform, and dry the resulting crystals under vacuum at 20° C. for 3 hours, then 50° C. for 18 hours, and finally 250° C. for 18 hours. Cool resulting dried crystals to ambient temperature under vacuum, and release vacuum so as to separately give active-pore form aminated (—NH₂) zinc-terephthalate acid framework products of Runs 1 and 2 of Example 1. Run a CO₂ gas sorption on the product of Run 1 two times and plot results in FIG. 1. FIG. 1 shows a synergistic CO₂ gas sorption effect for the product of Example 1. Obtain a PXRD on the product of Run 1, which PXRD is graphically presented in FIG. 2. The PXRD pattern is consistent with a MOF structure. Analyze the product of Run 2 using elemental analysis: C, 35.00%; H, 1.94%, N, 1.98%, and determine the product of Run 2 is a 37.5 mol %-aminated (—NH₂) zinc-terephthalate acid frameworks (based on actual molar ratio). Determine total pore volume of the product of Run 2 to be 0.36 cubic centimeters per gram (cm³/g) using the procedure of ASTM D4222-03 (2008). The datum shows a synergistic total pore volume effect for the product of Example 1.

### Example 2

preparation of 50 mol %-aminated (—NH₂) zinc-terephthalate acid frameworks (based on expected molar ratio). Repeat the procedure of Example 1 except use 0.68 g (0.00415 mol) of terephthalic acid and 0.75 g (0.00414 mol) 2-aminoterephthalic acid to give the 50 mol %-aminated (—NH₂) zinc-terephthalate acid framework of Example 2.

### Example 3

preparation of 50 mol %-aminated (—NH₂) zinc-terephthalate acid frameworks (based on expected molar ratio). Repeat the procedure of Example 1 except use 2.07 g (0.0125 mol) of terephthalic acid and 2.25 g (0.0124 mol) 2-aminoterephthalic acid to give the 50 mol %-aminated (—NH₂) zinc-terephthalate acid framework of Example 3.

Choose products of two of Run 1 of Example 1 and Examples 2-3 and determine total pore volume to be 0.30 cm³/g and 0.24 cm³/g using the procedure of ASTM D4222-03 (2008). The data show a synergistic total pore volume effect for two of the products of Run 1 of Example 1 and Examples 2 and 3 (the total pore volume of the product of the third Example is not determined).

### Example 4

preparations of aminated (—NH₂) zinc-terephthalate acid frameworks, respectively (65 mol %-aminated based on expected molar ratio). Runs 1 and 2: repeat the following procedure two times: Repeat the procedure of Example 1 with 13.64 g (0.0459 mol) of Zn(NO₃)₂.6H₂O and 0.96 g (0.0058 mol) terephthalic acid and 1.96 g (0.0108 mol) 2-aminoterephthalic acid to separately give active-pore form of the aminated (—NH₂) zinc-terephthalate acid framework products of Runs 1 and 2 of Example 4. Analyze the product of Run 2 of Example 4 using elemental analysis: C, 34.24%; H, 1.98%, N, 2.68%, and determine the product of Run 2 is a 51.7 mol %-aminated (—NH₂) zinc-terephthalate acid framework based on actual molar ratio. Determine total pore volume of the product of Run 2 to be 0.42 cm³/g using the procedure of ASTM D4222-03 (2008). The datum shows a synergistic total pore volume effect for the product of Example 4.

### Example 5

preparation of aminated (—NH₂) zinc-terephthalate acid frameworks, respectively (25 mol %-aminated based on expected molar ratio). Repeat the procedure of Example 1 except use a different amount of 2-aminoterephthalic acid so as to give a 25:75 starting molar ratio of 2-aminoterephthalic acid to terephthalic acid. Run a CO₂ gas sorption with Example 5 two times and plot results in FIG. 1. FIG. 1 shows a synergistic CO₂ gas sorption effect for the product of Example 5.

### Example 6

preparation of aminated (—NH₂) zinc-terephthalate acid frameworks, respectively (10 mol %-aminated based on expected molar ratio). Repeat the procedure of Example 1 except use a different amount of 2-aminoterephthalic acid so as to give a 10:90 starting molar ratio of 2-aminoterephthalic acid to terephthalic acid.

### Example 7

preparations of aminated (—NH₂) zinc-terephthalate acid frameworks (75 mol %-aminated based on expected molar ratio). Runs 1 and 2: repeat the following procedure two times: Repeat the procedure of Example 1 except use 0.68 g (0.0041 mol) of terephthalic acid and 2.26 g (0.0125 mol) 2-aminoterephthalic acid to separately give the aminated (—NH₂) zinc-terephthalate acid framework products of Runs 1 and 2 of Example 7. Run a CO₂ gas sorption on the product of Run 1 of Example 7 two times and plot results in FIG. 1. Determine total pore volume of the product of Run 1 to be 0.31 cm³/g using the procedure of ASTM D4222-03 (2008). The datum shows a synergistic total pore volume effect for the product of Example 7. Analyze the product of Run 2 of Example 7 using elemental analysis: C, 33.29%; H, 2.14%, N, 3.15%, and determine the product of Run 2 is a 61.6 mol %-aminated (—NH₂) zinc-terephthalate acid framework based on actual molar ratio. Determine total pore volume of the product of Run 2 to be 0.32 cm³/g using the procedure of ASTM D4222-03 (2008). The datum shows a synergistic total pore volume effect for the product of Example 7.

In FIG. 1 “Example” is abbreviated as “Ex.” The data for Run 1 of Example 7 in FIG. 1 do not show an enhanced (i.e., synergistic) CO₂ gas adsorption capacity for the product of Run 1. The reason for this is unclear. The data for Example 5 and Example 1 (Run 1) in FIG. 1 show that the PAMOFs of the invention are characterized by high and enhanced (i.e., synergistic) CO₂ gas adsorption capacity. This enhanced CO₂ gas adsorption capacity is not predictable and show that the PAMOFs are useful for flue gas and natural gas “sweetening” applications as well as the other applications mentioned previously herein.

As shown by the Examples, the present invention has the uses and advantages described previously herein, especially those listed in the Brief Summary of the Present Invention. For example, the enhanced PAMOF is useful for removing CO₂ gas from a separable gas mixture comprising CO₂ gas and at least one adsorption-resistant gas. The present invention is useful for, among other things, flue gas and natural gas “sweetening” applications. The enhanced PAMOF advantageously gives a synergistic improvement (increase) in CO₂ gas sorption, total pore volume, or both compared to either 100 mol % aminated MOF, 0 mol % MOF, and PAMOF that fall outside the range of the synergistically effective ratio.

1. An enhanced partially-aminated metal-organic framework characterizable in its active-pore form by a synergistic CO₂ gas sorption effect.

2. A process for making an enhanced partially-aminated metal-organic framework characterizable in its active-pore form by a synergistic CO₂ gas sorption effect, the process comprising contacting in a dispersion medium a metal salt with a synergistically effective ratio of a multi-carboxylic acid and an amino-substituted derivative of the multi-carboxylic acid, or acceptable salts thereof, or any combination thereof, and allowing the enhanced partially-aminated metal-organic framework to form and crystallize therefrom, the enhanced partially-aminated metal-organic framework defining a plurality of pores.

3. The process as in claim 2, the process comprising a process for making an enhanced partially-aminated zinc-terephthalate framework, the process comprising contacting in the dispersion medium a zinc salt with a synergistically effective ratio of an amino-substituted terephthalic acid, or acceptable salt thereof (amino-substituted terephthalic/terephthalate species) and terephthalic acid, or acceptable salt thereof (terephthalic/terephthalate species), or any combination thereof, and allowing the enhanced partially-aminated zinc-terephthalate framework to form and crystallize therefrom, the enhanced partially-aminated zinc-terephthalate framework defining a plurality of pores.

4. The process as in claim 3, wherein the synergistically effective ratio is a molar ratio of total moles of the amino-substituted terephthalic/terephthalate species to total moles of the terephthalic/terephthalate species of from 30:70 to 70:30 based on total pore volume as determined by ASTM D4222-03 (2008) and actual molar ratio of total moles of the amino-substituted terephthalic/terephthalate species to total moles of the terephthalic/terephthalate species based on C,H,N elemental analysis.

5. The process as in claim 2, wherein the enhanced partially-aminated metal-organic framework further comprises the dispersion medium and is characterizable as being a blocked-pore form of the enhanced partially-aminated metal-organic framework.

6. The process as in claim 5, the process further comprising a step of removing the dispersion medium from the enhanced partially-aminated metal-organic framework so as to give an active-pore form of the enhanced partially-aminated metal-organic framework, which active-pore form is characterizable by a synergistic CO₂ gas sorption effect or total pore volume effect.

7. An enhanced partially-aminated metal-organic framework as prepared by the process as in claim 2.

8. The enhanced partially-aminated metal-organic framework as in claim 1, the enhanced partially-aminated metal-organic framework comprising the active-pore form thereof.

9. A manufactured article comprising the enhanced partially-aminated metal-organic framework as in claim 8.

10. The manufactured article as in claim 9, the manufactured article comprising a combustion engine containing-vehicle exhaust system comprising an acid gas-adsorbing effective amount of the enhanced partially-aminated metal-organic framework; a combustion furnace exhaust system comprising an acid gas-adsorbing effective amount of the enhanced partially-aminated metal-organic framework; an oil or natural gas well-head vent system comprising an acid gas-adsorbing effective amount of the enhanced partially-aminated metal-organic framework; or an acid gas container comprising an acid gas-adsorbing effective amount of the enhanced partially-aminated metal-organic framework.

11. A separation method of separating an acid gas from a separable gas mixture comprising the acid gas and at least one adsorption-resistant gas, the method comprising contacting the active-pore form of the enhanced partially-aminated metal-organic framework as in claim 8 with the separable gas mixture; allowing the acid gas of the separable gas mixture to penetrate into the pores of, and adsorb onto, the enhanced partially-aminated metal-organic framework; and removing an enriched adsorption-resistant gas portion of the separable gas mixture from the enhanced partially-aminated metal-organic framework, wherein the enriched adsorption-resistant gas portion of the separable gas mixture has a lower concentration of the acid gas than does the separable gas mixture.

12. The separation method as in claim 11, wherein the separable gas mixture comprises a flue gas or natural gas and the acid gas comprises CO₂ gas, at least some of which adsorbs onto the active-pore form of the enhanced partially-aminated metal-organic framework to give a CO₂ gas-partially-aminated metal-organic framework composition.

13. A CO₂ gas-partially-aminated metal-organic framework composition as described in claim 12.

14. An enhanced partially-aminated zinc-terephthalate framework characterizable in its active-pore form by a synergistic CO₂ gas sorption effect or total pore volume effect.
